(19) United States
(12) Patent Application Publication
(10) Pub. No.: US 2004/0084508 A1
(43) Pub. Date: May 6, 2004

(54) Method for constraining the spread of solder during reflow for preplated high wettability lead frame flip chip assembly

(75) Inventors: John Briar, Singapore (SG); Roman Perez, Singapore (SG); Kee Kwang Lau, Singapore (SG); Alex Chew, Singapore (SG)

Correspondence Address: GEORGE O. SAILE & ASSOCIATES, 28 DAVIS AVENUE, POUGHKEEPSIE, NY, 12603, US

(73) Assignee: Advanpack Solutions Pte. Ltd.

(21) Appl. No.: 10/283,442

(22) Filed: Oct. 30, 2002

(51) Int. Cl. B23K 31/00

(52) U.S. Cl. 228/180.21

(57) ABSTRACT

A method and structure for controlling solder spread in a predefined/designed area during flip chip assembly build is disclosed. Using conventional processes used in the art blind holes or dimples are incorporated onto the lead frame which then act as containers or wells trapping the solder and thereby preventing it from spreading wider.

### FIELD OF THE INVENTION

The present invention relates generally to a high density semiconductor flip chip memory package and more specifically to the fabrication of a lead frame assembly in which a method for solder spread and solder bump thickness control is disclosed.

### BACKGROUND OF THE INVENTION

As current and future microelectronic packaging requirements trend towards the application of large size dies with high-density bumps, and the demand for denser, lighter, smaller, thinner and faster electronic products better control of solder spread during reflow, as well as, thicker solder thickness has become imperative. The present invention provides a method for fabricating a high density fine-pitch lead frame flip chip assembly using a dimple feature build onto the lead frame.

U.S. Pat. No. 6,386,436 to Hembree describes a method of forming solder bump interconnections for flip chip assemblies.

U.S. Pat. No. 6,386,433 to Razon et al. discloses a solder ball delivery and reflow method and apparatus.

U.S. Pat. No. 6,056,191 to Brouillette et al. shows a method and apparatus for forming solder bumps.

U.S. Pat. No. 6,045,032 to Longgood et al. describes a method of preventing solder reflow of electrical components during wave soldering.

### SUMMARY OF THE INVENTION

Accordingly, it is an object of the present invention to provide a lead frame structure and method for the fabrication of said structure to control the solder spread during the reflow process in the construction of a fine-pitch microelectronic flip chip package.

It is another object of the invention to provide a means for better control solder spread.

In yet another objective of the present invention is to assure thicker solder thickness after reflow with improved reliability performance.

In order to accomplish these and other objectives of the invention, a method is provided for constraining the spread of solder by means of a dimple build into the substrate at solder bump locations of a semiconductor IC chip in a lead frame flip chip package.

In accordance with the present invention the lead frame may comprise any of the following four categories of materials: nickel-iron, clad strip, copper and copper based alloys. The lead frame is personalized using photolithography patterning technology with a dimple built directly into the substrate at the solder bump location.

### BRIEF DESCRIPTION OF THE DRAWINGS

The foregoing and other objects, aspects and advantages of the present invention will be more clearly understood from the following detailed description taken in conjunction with the accompanying drawings. The drawings illustrate like reference numerals designating similar or corresponding elements, regions and portions and in which:

FIG. 1 is a cross-sectional representation of the invention, showing a lead frame structure without dimple illustrating solder overflow.

FIG. 2 is a cross-sectional representation of a preferred embodiment of the present invention showing the lead frame structure with dimple built in acting as a solder well or trap.

### DETAILED DESCRIPTION OF THE PREFERRED EMBODIMENT

Problems Discovered by the Inventors

The inventors have discovered the following problems and disadvantages with the current practice:

1. For large size devices thermomechanical stress buildup leads to fails at the interconnect joint between bump/device resulting from CTE mismatch between chip and substrate which is exacerbated when a means for solder thickness control during reflow is not implemented.

2. Flip chip structures utilizing spherical and pillar bump interconnects have been limited in meeting fine pitch wiring requirements, because of failure generated on a device from the stress imposed on the silicon by the interconnect solder bumps, leading to the need for solder bump size thickness control and solder spread which if not contained results in reduced stand-off causing underfill reliability issues.

3. Fine pitch wiring requirements have introduced process complexity, and reduced yields where thicker solder thickness after reflow cannot be efficiently controlled in during the packaging build process.

4. The process as practiced in the current art using conventional methods lead to limited solder bump thickness which lends to exposure to reduced yields, and short/long term reliability performance issues in large die, high density applications.

Initial Structure

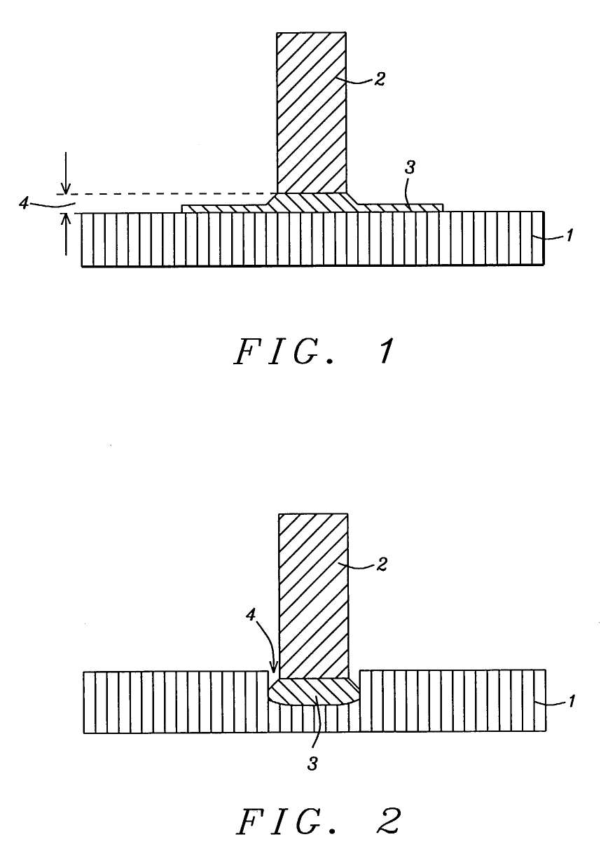

Referring to the drawings, and more particularly to FIG. 1, there is shown a cross-sectional view of a lead frame without dimple. Structure 1 is preferably a chip attach substrate and is also understood to possibly include a dam that prevents plastic from rushing out between leads during the molding operation as well as electrical and thermal conductor from chip to board. FIG. 1 may also be a cross-sectional representation of a substrate having a base layer 1 which can be composed of pre-plated palladium, or a material selected from three categories of materials, such as, nickel-iron, clad strip, and copper-based alloys. Furthermore, FIG. 1 illustrates copper terminal pad 2 (of which flip chip reflowed solder balls are subsequently deposited) as well as solder overflow 3 and solder thickness 4.

FIG. 2 is a cross-sectional view of the preferred structure of the invention illustrating lead frame with dimple. In a key feature of the invention FIG. 2 illustrates a dimple 4 which acts as a trap or well/blind hole built onto the lead frame 1. Thus, showing a means for controlling solder spread from predefined as designed area during the flip chip assembly process.

Key Steps of the Invention

The process of the invention may be best understood with respect to FIG. 2. FIG. 2 is comprised of a lead frame metal rolled strip stock substrate 1 typically of 0.20 mm strip thickness on which patterned layers are formed by chemical milling using photolithography and metal dissolving chemicals are used to etch a pattern in the metal substrate. Lead frame substrates may also be fabricated by a stamping process in which metal is mechanically removed from the strip stock using tungsten carbide progressive dies. The lead frame metal substrate 1 is either bare (not plated) or pre-plated with palladium and chromium/copper (Cr/Cu) or titanium/copper (Ti/Cu) conductors are patterned for by standard deposition methods, for example, by a combination of plating and as practiced in the art sputtering and conventional photolithography methods. A prebuilt dimple or well solder trap 4 is selectively patterned at the location of the solder bumps etched on the substrate followed by deposition of flip chip solder bumps 3. The dimple 4 opening diameter and depth is dependent on the diameter of the solder ball. Typically, solder ball diameter ranges from 100 um to 300 um. Next chip attach to the copper terminal pad 2 of the device using the flip chip solder bump 3 interconnect reflow process is performed. In the final step the total assembly comprising, chip electrical interconnects and lead frame is covered with a polymeric encapsulant. The advantages of the invention is described below.

Advantages of the Present Invention

The advantages of the present invention include:

1. Allows for control of solder spread during reflow.

2. Provides for achievement of enhanced solder thickness control after reflow and reduction of thermal and mechanical stress under solder bumps resulting in improved assembly process yields.

3. Demonstrates improved reliability performance with solder thickness control.

4. Formation of a robust flip chip structure/package meeting the requirements of fine pitch, high pin count and large size high density devices.

While the present invention has been described and illustrated with respect to preferred embodiments, it is not intended to limit the invention, except as defined by the following claims. Furthermore, numerous modifications, changes, and improvements will occur to those skilled in the art without departing from the spirit and scope of the invention.

We claim:

1. A method of manufacturing an integrated circuit package for preventing solder spread, comprising the steps of:
providing a substrate, having thereover attached a semiconductor device having formed thereover a solder or pillar bump which is comprised of lead or lead free solder;
providing a lead frame or substrate with pre-built blind hole dimple;
attaching said semiconductor device to said lead frame or substrate.

2. The method of claim 1 wherein said blind hole or dimple is formed onto the lead frame by an etching process.

3. The method of claim 1 wherein said blind hole or dimple is formed onto the lead frame by a stamping process.

4. The method of claim 1 wherein each blind hole or dimple is incorporated onto the lead frame by a molding process.

5. The method of claim 1 wherein said lead frame material is selected from categories of materials comprising: nickel-iron, clad strip, and copper and copper-based alloys.

6. The method of claim 1 wherein said lead frame material is pre-plated with a metal coating such as, palladium.

7. The method of claim 1, wherein said IC chip and pre-plated palladium lead frame metallization layer comprises Cu (copper), and said IC chip seed bottom metallization layer is selected from the group comprising chrome copper.

8. The method of claim 1, wherein said patterning of each IC top and/or bottom metallization layers comprises photoprocessing and etching.

9. The method of claim 1 wherein said adhesion layer is formed of a material selected from the group comprising titanium and chromium.

10. The method of claim 1 wherein said solder lead frame IC chip interconnect capped conductive pad comprises a bonding pad.

11. The method of claim 1 wherein said IC chip UBM top and bottom metallization and seed layers are selected from the group comprising Ti/Cu or Cr/CrCu/Cu.

12. The method claim 1 wherein said semiconductor IC spherical or pillar bumps are comprised of Cu (copper).

13. The method of claim 1 wherein said semiconductor IC is capped with lead or lead free alloys of solder material selected from the group comprising of SnAg, SnPb, SnAgCu, and SnBi

14. The method of claim 1 wherein said bottom nonconductive initial passivation layer of IC chip is selected from the group comprising of Si₃N₄, SiO₂, Si₃N₄/SiO₂.

15. The method of claim 1 wherein said diameter of the solder bump is in the range of 60 um to 300 um.

16. The method of claim 1 wherein said passivated overcoat layer of the substrate/device is selected from the group comprising of an organic low dielectric laminate, such as, polyimide and benzocyclobutene.

17. The method of claim 1 wherein said passivated overcoat layer of the substrate/device is selected from class of materials known as thermoset and thermoplastic polymers.

18. The method of claim 1 wherein said opening of bottom initial passivation layer is in the range of 50 um to 250 um.

19. The method of claim 1 forming a flip chip structure, comprising the steps of:
providing a semiconductor wafer depositing a seed layer over said wafer;
forming a bottom metallization layer over said seed layer; forming a top metallization layer over said middle metallization layer; patterning said top and bottom metallization layers, using conventional photolithography processes passivation and re-passivation layers are formed around the via openings and having a plurality of bond pads forming a solder interconnect with bond pads.

20. The method of claim 19 wherein the conductive metallization layers are comprised of material selected from the group consisting of copper and aluminum.

21. The method of claim 19 wherein the top and bottom metallization and seed layers are comprised of a material selected from the group consisting of Ti/Cu, Cr/Cu, Ti/Ni, and Ni/Au.

22. The method of claim 19 wherein the photoresist layers being comprised of photoresist materials of dry resist film and liquid photoresists.

23. An integrated circuit package for preventing solder spread, comprising:
a substrate, including a semiconductor device having formed thereover a C-4 solder or solder or pillar bump which is comprised of lead or lead free solder;
a lead frame or substrate with pre-built blind hole dimple;
said semiconductor device attached to said lead frame or substrate.

24. The package of claim 23 wherein said lead frame material is selected from materials comprising: nickel-iron, clad strip, and copper and copper-based alloys.

25. The package of claim 23 wherein said lead frame material is pre-plated with a metal coating such as, palladium.

26. The package of claim 23, wherein said IC chip and pre-plated palladium lead frame metallization layer comprises Cu (copper), and said IC chip seed bottom metallization layer comprises chrome copper.

27. The package of claim 23 wherein said adhesion layer is formed of a material selected from the group comprising titanium and chromium.

28. The package of claim 23 wherein said solder lead frame IC chip interconnect capped conductive pad comprises a bonding pad.

29. The package of claim 23 wherein said semiconductor IC spherical or pillar bumps are comprised of Cu (copper).

30. The package of claim 23 wherein said semiconductor IC is capped with lead or lead free alloys of solder material selected from the group comprising of SnAg, SnPb, SnAgCu, and SnBi.

31. The package of claim 23 wherein said diameter of the solder bump is in the range of 60 um to 300 um.

32. The package of claim 23 wherein said passivated overcoat layer of the substrate/device is selected from the group comprising of an organic low dielectric laminate, such as, polyimide and benzocyclobutene.

33. The package of claim 23 wherein said passivated overcoat layer of the substrate/device is selected from class of materials known as thermoset and thermoplastic polymers.

34. The package of claim 23 wherein said bonding pad is comprised of copper or aluminum.
